(19) United States
(12) Patent Application Publication
(10) Pub. No.: US 2015/0323916 A1
(43) Pub. Date: Nov. 12, 2015

(54) FAST CHANGE PLANNING SYSTEM, FAST CHANGE PLANNING METHOD, AND FAST CHANGE PLANNING PROGRAM

(71) Applicants: NEC CORPORATION, Tokyo (JP); VANDERBILT UNIVERSITY, Nashville, TN (US)

(72) Inventors: Takayuki KURODA, Tokyo (JP); Aniruddha Suresh GOKHALE, Nashville, TN (US)

(73) Assignees: VANDERBILT UNIVERSITY, Nashville, TN (US); NEC CORPORATION, Tokyo (JP)

(21) Appl. No.: 14/471,773

(22) Filed: Aug. 28, 2014

Related U.S. Application Data
(60) Provisional application No. 61/991,075, filed on May 9, 2014.

(51) Int. Cl. G05B 15/02

(52) U.S. Cl. CPC G05B 15/02

(57) ABSTRACT

A fast change planning system includes: a state machine set division unit 11 which divides a state machine set made up of one or more state machines, into a state machine group set; and a state machine set integration unit 12 which integrates transition orders derived from each of the state machine groups obtained by dividing the state machine group set.

This application is based upon and claims the benefit of priority from U.S. provisional application No. 61/991,075, filed on May 9, 2014, the disclosure of which is incorporated here in its entirety by reference.

### TECHNICAL FIELD

The present invention relates to a fast change planning system, a fast change planning method, and a fast change planning program.

### BACKGROUND ART

Change management is intended to, upon changing a system, reduce the work of the manager and the change operator of the system to be changed and the influence on the users of the system to be changed. For example, in the case where the system to be changed is a complex system made up of a plurality of components, the change operation is complex. The complex change operation increases the work of the operator and the manager who supervises the operation by the operator. This affects the users of the system more significantly.

Particularly in the case where the components constituting the system have dependence relationships, the change operation tends to be complex because the order in which the components undergo the change operation is critical. Suppose the system includes a component A and a component B. The dependence between the components is the relationship between two elements such that, for the component A to function properly, the component B needs to function properly.

The component A depends on the component B in the above-mentioned example. Operations to construct the system including the component A and the component B need to be ordered so that the component B is constructed first and the component A is constructed next.

A change planning system is a system that automatically generates a plan of operations necessary to change the system while taking such dependence into consideration. Note that a change planning system in the present invention is a system that derives necessary operations and an appropriate operation procedure from input data that includes: the current state of each component; and the desired state of each component after the change. In the change planning system, information about the dependence between the components and information about the operations for the components are defined beforehand.

With use of the above-mentioned change planning system, the manager can efficiently generate the operation procedure effective in carrying out the complex change operation, and the operator can efficiently carry out the operation on the basis of the generated effective operation procedure. This is expected to reduce the influence on the users of the system to be changed.

A number of studies and products related to such a change planning system are already known. Non Patent Literature (NPL) 1 describes a method of defining a system to be managed as multiple state machine sets. According to the method described in NPL 1, a transition condition of a transition in each state machine set is described using a state in a state machine other than the state machine including the transition.

A state machine represents a component included in the system. Each state of the state machine represents a possible state of the component. A transition includes information of an operation when changing the state of the component. A transition condition represents the dependence of the operation corresponding to the information included in the transition.

A change plan based on the system definition method described above is expected to be more effective than change plans based on other methods, because a wide range of situations can be planned and definitions are reusable. The present invention is intended for a system based on this definition method. The intended system is hereafter simply referred to as “change planning system”.

The change plan for the system described as the state machine set is generated by determining, when all state machines have the current state and at least one of the state machines has the desired state, the transition order for enabling all state machines in which the desired state is designated to transition from the current state to the desired state while satisfying transition conditions. NPL 1 describes such a change plan generation method.

### CITATION LIST

### Non Patent Literature(s)

NPL 1: S. Hagen and A. Kemper, “Model-based planning for state-related changes to infrastructure and software as a service instances in large data centers,” in Cloud Computing (CLOUD), 2010 IEEE 3rd International Conference on July 2010, pp. 11-18.

### SUMMARY

An exemplary object of the present invention is to provide a fast change planning system, a fast change planning method, and a fast change planning program that can reduce computational effort in generation of a change plan for a large-scale system.

A fast change planning system according to the present invention includes: a state machine set division unit which divides a state machine set made up of one or more state machines, into a state machine group set; and a state machine set integration unit which integrates transition orders derived from each of the state machine groups obtained by dividing the state machine group set.

A fast change planning method according to the present invention includes: dividing a state machine set made up of one or more state machines, into a state machine group set; and integrating transition orders derived from each of the state machine groups obtained by dividing the state machine group set.

A non-transitory computer-readable recording medium having recorded therein a fast change planning program according to the present invention that, when executed by a computer: divides a state machine set made up of one or more state machines, into a state machine group set; and integrates transition orders derived from each of the state machine groups obtained by dividing the state machine group set.

### BRIEF DESCRIPTION OF THE DRAWINGS

FIG. 1 It is a block diagram depicting a structural example of Exemplary Embodiment 1 of a fast change planning system according to the present invention.

FIG. 2 It is an explanatory diagram depicting the concept of a state machine set.

FIG. 3 It is an explanatory diagram depicting an example of a textual definition of a state machine set.

FIG. 4 It is an explanatory diagram depicting an example of a transition order derivation result.

FIG. 5 It is an explanatory diagram depicting an example of a state machine group set generated by dividing a state machine set.

FIG. 6 It is an explanatory diagram depicting an example of a state machine group set including integrated transition order.

FIG. 7 It is an explanatory diagram depicting an example of a state machine group including a generated pseudo state machine.

FIG. 8 It is an explanatory diagram depicting an example of an integration result of transition orders for each state machine group.

FIG. 9 It is an explanatory diagram depicting an example of a result of converting a transition order integration result into single transition order.

FIG. 10 It is an explanatory diagram depicting another example of a state machine group set including integrated transition order.

FIG. 11 It is an explanatory diagram depicting another example of a state machine group including a generated pseudo state machine.

FIG. 12 It is an explanatory diagram depicting another example of an integration result of transition orders for each state machine group.

FIG. 13 It is an explanatory diagram depicting another example of a result of converting a transition order integration result into single transition order.

FIG. 14 It is a flowchart depicting operation of a state machine set change planning process by a fast change planning system 100.

FIG. 15 It is a flowchart depicting operation of a state machine set division process by the fast change planning system 100.

FIG. 16 It is a flowchart depicting operation of a process of assigning state machines to state machine groups by the fast change planning system 100.

FIG. 17 It is an explanatory diagram depicting an example of a stack used when assigning state machines to state machine groups.

FIG. 18 It is a flowchart depicting operation of a transition order derivation process and a transition order integration process by the fast change planning system 100.

FIG. 19 It is a block diagram depicting a structural example of Exemplary Embodiment 2 of a fast change planning system according to the present invention.

FIG. 20 It is an explanatory diagram depicting an example of a state machine group set for which transition order is computable in parallel.

FIG. 21 It is a block diagram schematically depicting a fast change planning system according to the present invention.

### DESCRIPTION OF EXEMPLARY EMBODIMENT

### Exemplary Embodiment 1

### Structure

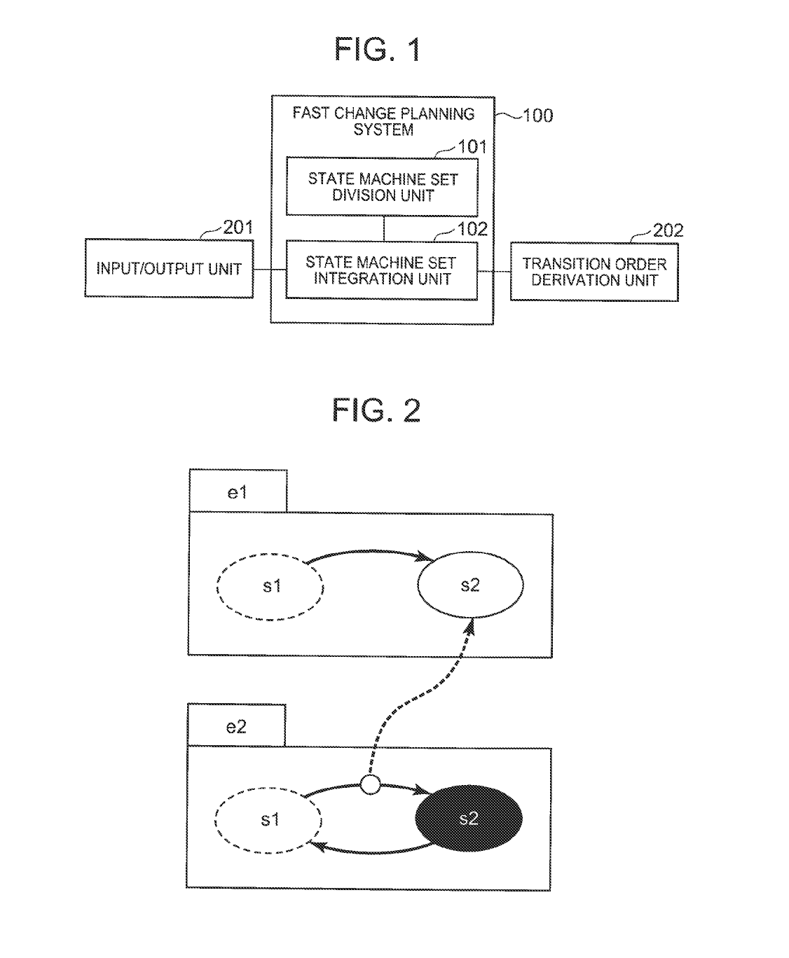

The following describes Exemplary Embodiment 1 of the present invention, with reference to drawings. FIG. 1 is a block diagram depicting a structural example of Exemplary Embodiment 1 of a fast change planning system according to the present invention. A fast change planning system 100 depicted in FIG. 1 includes a state machine set division unit 101 and a state machine set integration unit 102.

The state machine set division unit 101 has a function of dividing a state machine set into a state machine group set.

The state machine set integration unit 102 has a function of integrating transition orders derived for each state machine group.

The state machine set integration unit 102 is connected with the state machine set division unit 101 via a communication network or the like, so as to communicate with the state machine set division unit 101. The state machine set integration unit 102 is also connected with an input/output unit 201 and a transition order derivation unit 202 located outside the fast change planning system 100 via a communication network or the like, so as to communicate with the input/output unit 201 and the transition order derivation unit 202.

The transition order derivation unit 202 has a function of deriving transition order for enabling all state machines in which a desired state is designated to transition to the desired state, while satisfying transition conditions between state machines.

The state machine set integration unit 102 receives the state machine set input via the input/output unit 201. The state machine set integration unit 102 outputs the received state machine set to the state machine set division unit 101.

The state machine set division unit 101 divides the received state machine set into state machine groups including a plurality of state machines. The state machine set division unit 101 returns the generated state machine group set to the state machine set integration unit 102.

The state machine set integration unit 102 extracts a state machine group from the received state machine group set one by one. The state machine set integration unit 102 transmits the extracted state machine group to the transition order derivation unit 202.

The transition order derivation unit 202 derives transition order based on the received state machine group. The transition order derivation unit 202 returns the derived transition order to the state machine set integration unit 102.

The state machine set integration unit 102 integrates a plurality of transition orders received from the transition order derivation unit 202. The state machine set integration unit 102 converts the integrated transition order into single transition order. The state machine set integration unit 102 transmits single transition order finally obtained as a result of repeating integration and conversion, to the input/output unit 201. The input/output unit 201 outputs the received transition order.

The state machine set in this exemplary embodiment corresponds to a system to be managed and a change request for the system to be managed. The state machine set is made up of one or more state machines. Each state machine represents a component included in the system.

The state machine can have a plurality of states. A state can transition to another state in the same state machine. The state machine always has one current state, and can transition to any number (including 0) of desired states. In other words, the state machine includes a plurality of states. In the case where a plurality of desired states are designated, the desired state of the state machine may be any of the designated states. In the case where no desired state is designated, the desired state of the state machine may be any state. A transition condition of a transition is designated according to a state in a state machine other than a state machine including the transition.

FIG. 2 is an explanatory diagram depicting the concept of a state machine set. In FIG. 2, the rectangles each represent a state machine. The ellipses each represent a state. The solid arrows each represent a transition. The dotted arrow represents a transition condition. The dotted ellipses each represent a current state. The black ellipse represents a desired state. The circle on the arrow of the transition represents the start point of the arrow of the transition condition. State machines and the like in other drawings are represented in the same way as in FIG. 2.

FIG. 2 depicts a state machine set made up of two state machines “e1” and “e2”. Each of “e1” and “e2” includes two states “s1” and “s2”.

As depicted in FIG. 2, “s1” in “e1” includes a transition to “s2”. Each of “s1” and “s2” in “e2” includes a transition to the other state. The transition from “s1” to “s2” in “e2” has the state “s2” of “e1” as a transition condition. Moreover, “e1” has “s1” as a current state, and “e2” has “s1” as a current state and “s2” as a desired state.

For example, the state “s1” of the state machine “e1” is hereafter denoted by “e1(s1)”, and the transition of the state machine “e1” from the state “s1” to the state “s2” is hereafter denoted by “e1(s1,s2)”, for sake of simplicity.

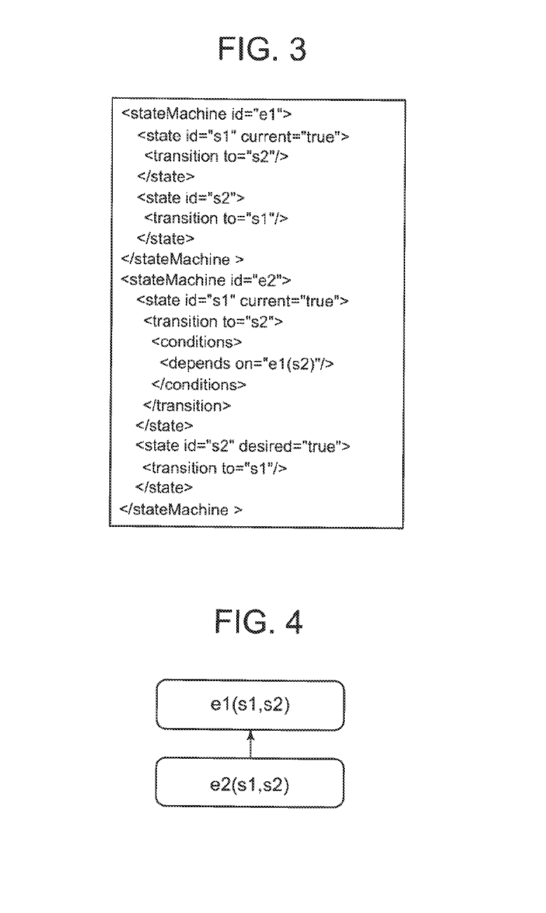

FIG. 3 is an explanatory diagram depicting an example of a textual definition of a state machine set. FIG. 3 depicts an example of the definition of the state machine set depicted in FIG. 2, as an example of representation using Extensible Markup Language (XML).

As depicted in FIG. 3, for example, each state machine is represented by a “stateMachine” tag. The ID of the state machine is represented by an “id” attribute of “stateMachine”. Each state of the state machine is represented by a “state” tag as a child element of the “stateMachine” tag. The ID of the state is represented by an “id” attribute of “state”.

As depicted in FIG. 3, the transition of the state is represented by a “transition” tag as a child element of the “state” tag. The ID indicating the state of the transition destination is represented by a “to” attribute of “transition”.

As depicted in FIG. 3, the transition condition of the transition is represented by a “conditions” tag as a child element of the “transition” tag. In the case where the transition has the state “s2” of the state machine “e1” as the transition condition, the transition condition is represented by describing a “depends” tag as a child element of the “conditions” tag and setting the “on” attribute of “depends” tag to “e1(s2)”. In the case where one transition has a plurality of transition conditions, the plurality of transition conditions are described using a plurality of “depends” tags as child elements of the “conditions” tag.

A change plan for the system based on the state machine set in this exemplary embodiment can be generated by finding such transition order that enables all state machines in which the desired state is designated to transition from the current state to the desired state while constantly satisfying all transition conditions. In the example of the state machine set depicted in FIG. 2, the transition order “(e1(s1,s2), e2(s1,s2))” is the simplest single solution.

FIG. 4 is an explanatory diagram depicting an example of a transition order derivation result. In FIG. 4, the rounded-corner rectangles each represent a transition. The arrow between the transitions represents the dependence between the transitions. In detail, the arrow between the transitions indicates the relationship that “e2(s1,s2)” is performed only after “e1(s1,s2)” is performed.

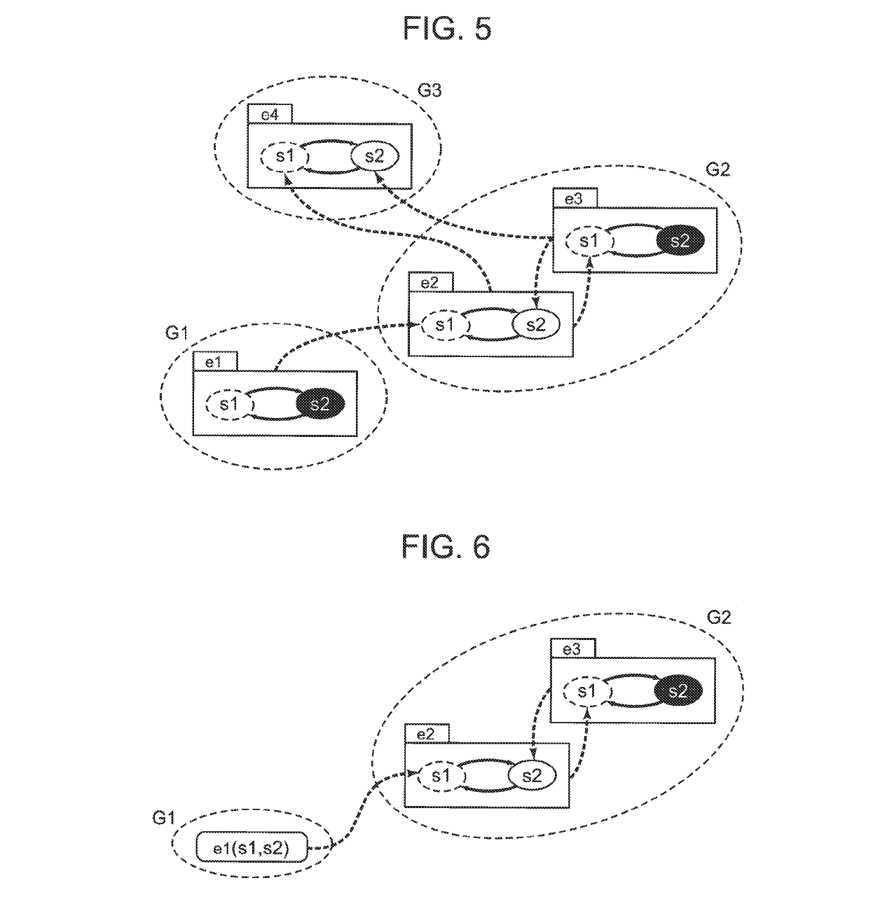

FIG. 5 is an explanatory diagram depicting an example of a state machine group set generated by dividing a state machine set. FIG. 5 depicts a situation where a state machine set made up of four state machines “e1”, “e2”, “e3”, and “e4” is divided into three state machine groups “G1”, “G2”, and “G3”. FIG. 5 depicts each arrow that corresponds to a transition condition from a state machine itself to a state in another state machine, unlike FIG. 2. The arrow indicates that all transitions in the state machine have the same transition condition as the transition condition corresponding to the arrow.

A transition condition in this exemplary embodiment induces a state machine whose state is designated as the transition condition, to transition to the designated state. In the case where the relationship between the inducing state machine and the induced state machine is one-sided, the final transition order is unaffected even when the transition order of the induced state machine is determined after the transition order of the inducing state machine is determined. In the case of a state machine set including a plurality of state machines that mutually induce transitions, however, the transition order needs to be determined while taking all relationships between state machines into consideration.

Hence, in this exemplary embodiment, the state machine set is divided in consideration of whether or not a plurality of transition conditions between state machines form a circle. The state machine set is divided so that all state machines between which a plurality of transition conditions form a circle belong to the same state machine group.

In the example depicted in FIG. 5, “e1” has a transition condition to “e2”, but tracing any transition condition(s) from “e2” does not reach “e1”. Since there is no circle of transition conditions between “e1” and “e2”, “e1” and “e2” are separated into different state machine groups.

In FIG. 5, “e2” has a transition condition to “e3”, and “e3” has a transition condition to “e2”. Since there is a circle of transition conditions between “e2” and “e3”, “e2” and “e3” are incorporated into the same state machine group.

Suppose a transition condition from “e4” to “e2” is defined instead of a transition condition from “e2” to “e4” depicted in FIG. 5. In such a case, a circle of transition conditions is formed between “e2”, “e3”, and “e4”. Thus, if a transition condition from “e4” to “e2” is defined, then the three state machines “e2”, “e3”, and “e4” are incorporated into the same state machine group.

The state machine set integration unit 102 computes the transition order in each generated state machine group, using the transition order derivation unit 202. The state machine set integration unit 102 integrates the computed transition orders.

FIG. 6 is an explanatory diagram depicting an example of a state machine group set including integrated transition order. The transition order in a state machine group including a state machine that induces a transition needs to be determined first. Accordingly, the transition order in the state machine group “G1” including the state machine “e1” which is a state machine designating a transition condition is computed first.

After the transition order in the state machine group “G1” is computed, the transition order in the state machine group “G2” is computed next, and the transition order in the state machine group “G3” is computed last. The computed transition order in the state machine group “G1” is simply one transition “e1(s1,s2)”.

The transition “e1(s1,s2)” includes a transition condition to “e2” which is a state machine in the state machine group “G2”. Therefore, the transition “e1(s1,s2)” needs to be taken into consideration when computing the transition order in the state machine group “G2”.

The state machine set integration unit 102 accordingly extracts each transition having a transition condition to a state machine in the state machine group for which the transition order is to be computed, from the transition order as the provisional result. The state machine set integration unit 102 generates a pseudo state machine by linking the extracted transition with pseudo states. The state machine set integration unit 102 adds the pseudo state machine to the state machine group subjected to the computation, and computes the transition order.

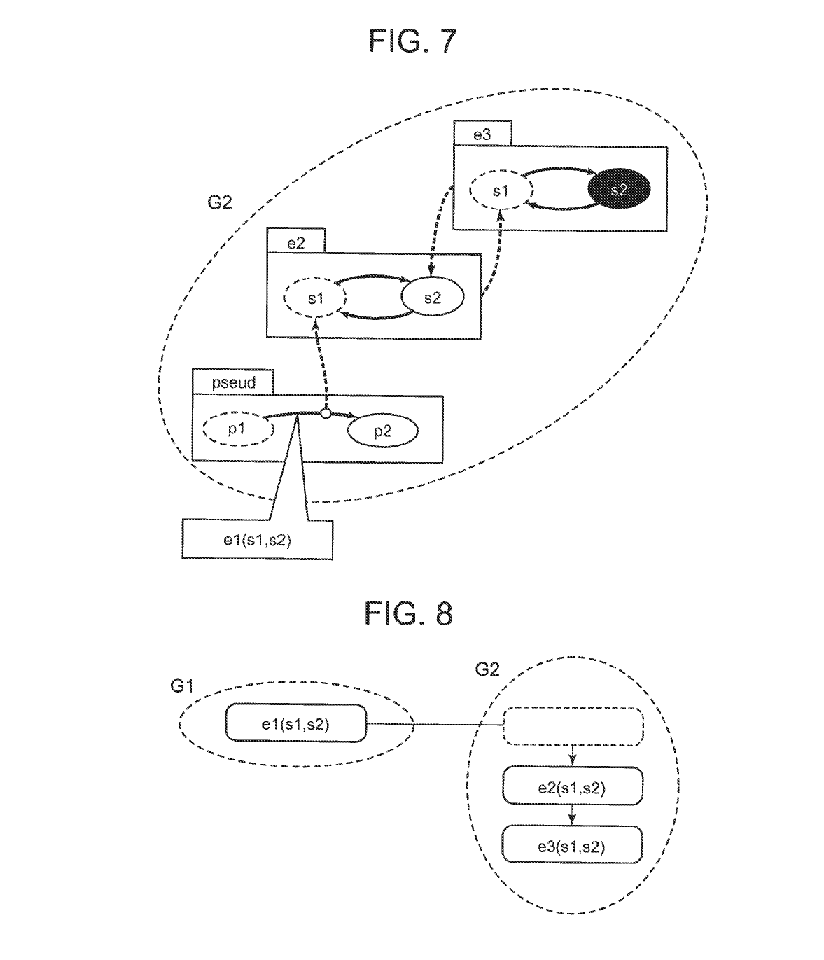

FIG. 7 is an explanatory diagram depicting an example of a state machine group including a generated pseudo state machine. FIG. 7 depicts a situation where a pseudo state machine “pseud” is generated by linking pseudo states “p1” and “p2” on the basis of the transition “e1(s1,s2)” depicted in FIG. 6 and “pseud” is added to the state machine group “G2”. The word balloon in FIG. 7 indicates that the pseudo states “p1” and “p2” are linked on the basis of the transition “e1(s1,s2)”.

The transition order computed on the basis of the state machine group depicted in FIG. 7 includes the pseudo transition. FIG. 8 is an explanatory diagram depicting an example of an integration result of transition orders for each state machine group.

The transition order in the state machine group “G2” depicted in FIG. 8 is the transition order including the pseudo transition, which is generated from the state machine group “G2” depicted in FIG. 7. The dotted rectangle in the state machine group “G2” corresponds to the pseudo transition. FIG. 8 depicts a situation where the pseudo transition in the state machine group “G2” is “e1(s1,s2)” in the state machine group “G1”.

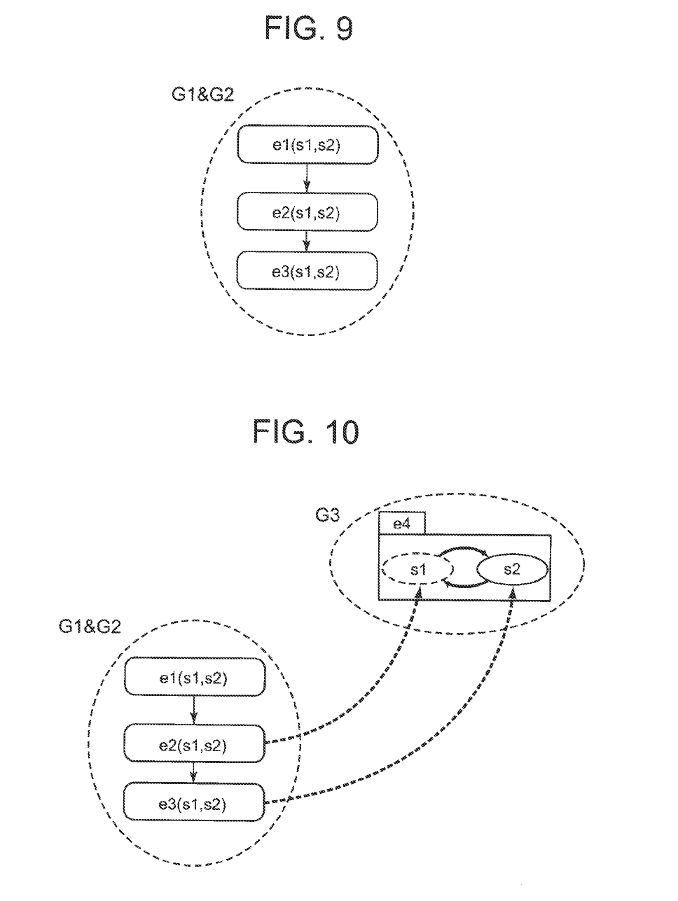

The state machine set integration unit 102 integrates the transition orders obtained from each state machine group, by transferring the dependence relationship of the pseudo transition with another transition to the original transition. FIG. 9 is an explanatory diagram depicting an example of a result of converting a transition order integration result into single transition order. FIG. 9 depicts a result of converting the transition orders in the two state machine groups “G1” and “G2” depicted in FIG. 8 into single transition order.

FIG. 10 is an explanatory diagram depicting another example of a state machine group set including integrated transition order. FIG. 10 depicts the relationship between the state machine groups “G1” and “G2” with the integrated transition order and the state machine group “G3”.

The transitions in the transition order depicted in FIG. 10 include two transitions having transition conditions to a state machine in the state machine group “G3”. The state machine set integration unit 102 generates a pseudo state machine having the two transitions with the transition conditions as pseudo transitions, when computing the transition order in the state machine group “G3”.

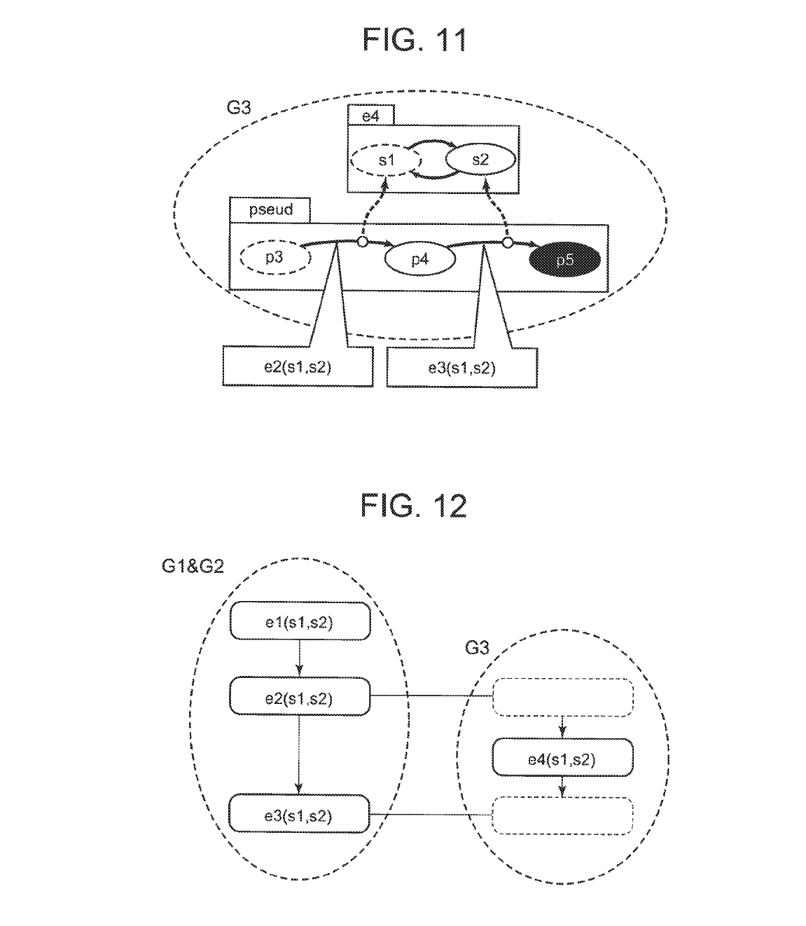

FIG. 11 is an explanatory diagram depicting another example of a state machine group including a generated pseudo state machine. FIG. 11 depicts the state machine group “G3” including a pseudo state machine, which is used when computing the transition order in the state machine group “G3”.

FIG. 11 depicts a situation where a pseudo state machine “pseud” is added to the state machine group “G3”. The pseudo state machine “pseud” depicted in FIG. 11 is generated by linking pseudo states “p3” and “p4” on the basis of the transition “e2(s1,s2)” depicted in FIG. 10 and linking pseudo states “p4” and “p5” on the basis of the transition “e3(s1,s2)” depicted in FIG. 10. The respective word balloons in FIG. 11 indicate that the pseudo states “p3” and “p4” are linked on the basis of the transition “e2(s1,s2)” and the pseudo states “p4” and “p5” are linked on the basis of the transition “e3(s1,s2)”.

FIG. 12 is an explanatory diagram depicting another example of an integration result of transition orders for each state machine group. FIG. 12 depicts the relationship between the transition order in the state machine group “G3” obtained as the computation result and the transition order obtained from the state machine groups “G1” and “G2”.

The transition order in the state machine group “G3” depicted in FIG. 12 is the transition order including the pseudo transitions, which is generated from the state machine group “G3” depicted in FIG. 11. FIG. 12 depicts a situation where the two pseudo transitions in the state machine group “G3” are “e2(s1,s2)” and “e3(s1,s2)” in the state machine group “G1 & G2”.

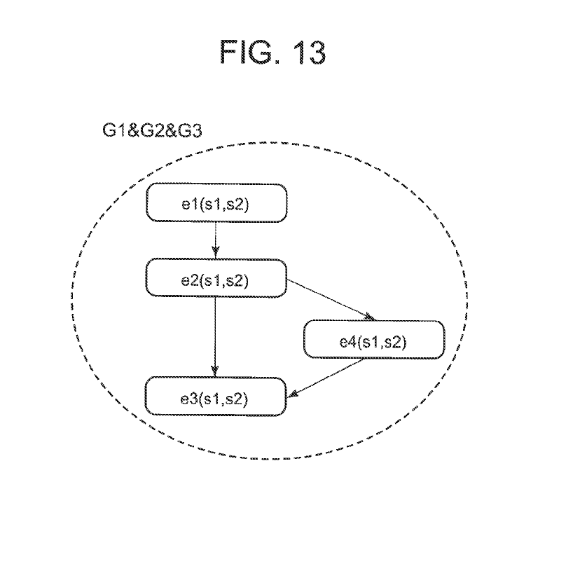

FIG. 13 is an explanatory diagram depicting another example of a result of converting a transition order integration result into single transition order. FIG. 13 depicts single transition order obtained by converting the integrated transition order of the two state machine groups “G1 & G2” and “G3” depicted in FIG. 12. The transition order depicted in FIG. 13 is the final result of integrating all transition orders obtained from the state machine groups “G1”, “G2”, and “G3”.

As a result of the division process and integration process described above, the computation of the transition order based on the four state machines is divided into the computation of the transition order in the state machine group “G1”, the computation of the transition order in the state machine group “G2”, and the computation of the transition order in the state machine group “G3”.

The computation of the transition order in the state machine group “G1” is based on one state machine. The computation of the transition order in the state machine group “G2” is based on three state machines including a pseudo state machine. The computation of the transition order in the state machine group “G3” is based on two state machines including a pseudo state machine. The number of state machines computed together in the computation of the transition order is reduced in this way.

The state machine set division unit 101 and the state machine set integration unit 102 in this exemplary embodiment are, for example, realized by a central processing unit (CPU) executing processes according to control of a program stored in a non-transitory computer-readable recording medium.

[Operation]

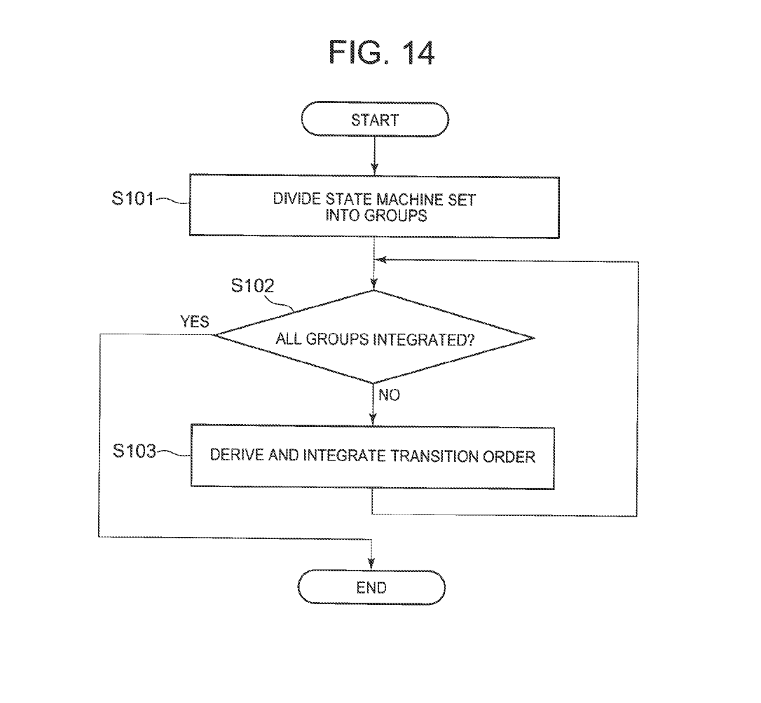

The following describes the operation of the fast change planning system 100 in this exemplary embodiment, with reference to FIG. 14. FIG. 14 is a flowchart depicting operation of a state machine set change planning process by the fast change planning system 100.

The state machine set integration unit 102 receives information of a state machine set from the input/output unit 201. The state machine set integration unit 102 outputs the received information of the state machine set to the state machine set division unit 101.

The state machine set division unit 101 divides the received state machine set into a plurality of state machine groups. The state machine set division unit 101 returns the generated state machine group set to the state machine set integration unit 102 (step S101).

The state machine set integration unit 102 then acquires, one by one, a state machine group for each of which transition order is computable, from the received state machine group set. A state machine group for which transition order is computable is a state machine group having a transition condition to a state machine in the state machine group itself, and having no dependence relationship with a state machine group of which transition order has not been computed.

The above-mentioned dependence relationship between state machine groups corresponds to, for example, the relationship of a predetermined state machine group with a state machine group in which the transition order needs to be computed beforehand in order to compute the transition order in the predetermined state machine group.

The state machine set integration unit 102 repeatedly performs the process of computing the transition order in a state machine group and the process of integrating the computed transition orders, on all state machine groups.

The state machine set integration unit 102 determines whether or not the transition orders in all state machine groups have been integrated (step S102). In the case where the transition orders in all state machine groups have been integrated (step S102: Yes), the state machine set integration unit 102 sets the obtained transition order integration result as the final result, and ends the process.

In the case where the transition orders in all state machine groups have not been integrated (step S102: No), the state machine set integration unit 102 acquires one uncomputed state machine group for which transition order is computable. The state machine set integration unit 102 computes the transition order in the acquired state machine group, and integrates the computed transition order with the provisional result (step S103). After the integration, the state machine set integration unit 102 performs the process in step S102 again.

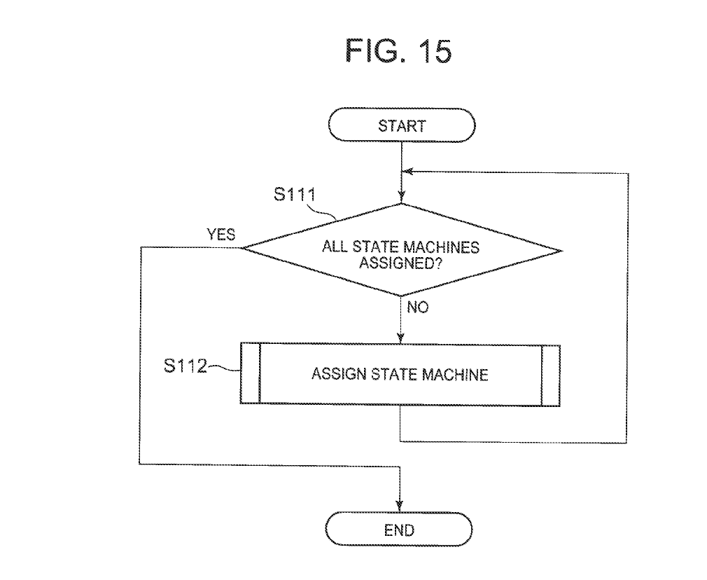

The following describes the process in step S101 in detail, with reference to FIG. 15. FIG. 15 is a flowchart depicting operation of a state machine set division process by the fast change planning system 100.

The state machine set division unit 101 acquires state machines from the received state machine set one by one. The state machine set division unit 101 assigns the acquired state machine to an appropriate state machine group. The state machine set division unit 101 repeatedly performs the assignment process on all state machines.

The state machine set division unit 101 determines whether or not all state machines included in the received state machine set have been assigned to state machine groups (step S111). In the case where all state machines have been assigned to state machine groups (step S111: Yes), the state machine set division unit 101 sets the state machine assignment result as the final result, and ends the process.

In the case where all state machines have not been assigned to state machine groups (step S111: No), the state machine set division unit 101 acquires any one unassigned state machine. The state machine set division unit 101 assigns the acquired state machine to a state machine group (step S112).

The process of assigning a state machine to a state machine group in step S112 has a process recursive call structure of calling a process of assigning another state machine related to the state machine assigned in the process to a state machine group.

In the case where a process call loop occurs, a recursive call in the loop needs to be stopped. To determine whether or not a call loop occurs, the state machine set division unit 101 passes stack data including chain information of state machines being processed, upon calling the process.

In the first process in step S112, the state machine set division unit 101 first calls the process of assigning a state machine to a state machine group. In other words, the state machine set division unit 101 calls the process with empty stack data. After assigning the state machine to the state machine group, the state machine set division unit 101 performs the process in step S111 again.

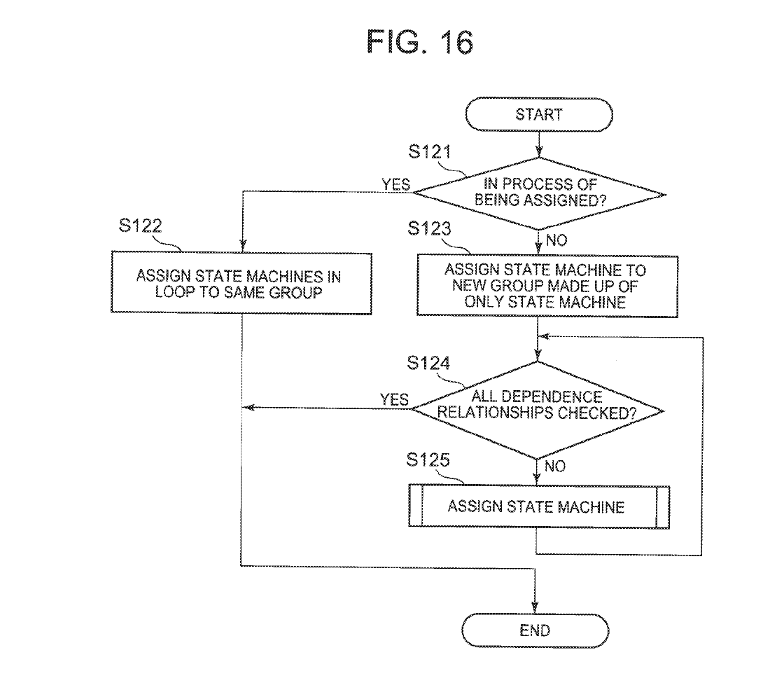

The following describes the process in step S112 in detail, with reference to FIG. 16. FIG. 16 is a flowchart depicting operation of a process of assigning state machines to state machine groups by the fast change planning system 100.

The state machine set division unit 101 determines whether or not the state machine to be processed is included in the stack (step S121). In the case where the state machine to be processed is included in the stack (step S121: Yes), the state machine set division unit 101 determines that the state machine to be processed is in the process of being assigned to a state machine group and is one of the state machines forming a circle of transition conditions.

The state machine set division unit 101 re-assigns all state machines forming the circle of transition conditions, to the same state machine group assigned to the state machine to be processed (step S122). After assigning the state machines to the same state machine group, the state machine set division unit 101 ends the process.

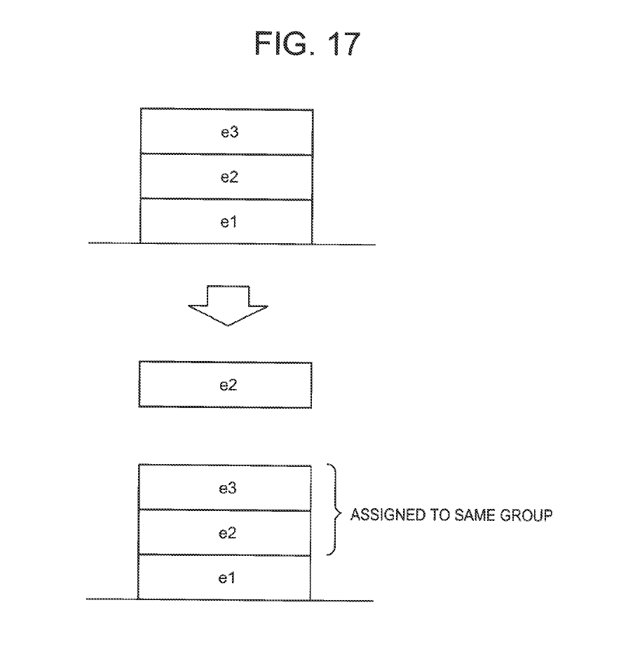

FIG. 17 is an explanatory diagram depicting an example of a stack used when assigning state machines to state machine groups. The upper stack depicted in FIG. 17 corresponds to the stack in the case where the process of assigning the state machine “e2” is called during the process of assigning the state machine “e1” and further the process of assigning the state machine “e3” is called during the process of assigning the state machine “e2”.

The lower stack depicted in FIG. 17 corresponds to the stack in the case where the process of assigning the state machine “e2” is called during the process of assigning the state machine “e3”, following the situation represented by the upper stack.

For example, the state machine set division unit 101 determines that the state machine “e2” subjected to the new assignment process is included in the stack, from the lower stack data depicted in FIG. 17. Having determined this, the state machine set division unit 101 re-assigns all state machines from the state machine at the top of the stack to the state machine “e2” subjected to the new assignment process, to the same state machine group assigned to the state machine “e2”.

In the case where, when re-assigning all state machines to the same state machine group, a state machine group to which a re-assigned state machine has belonged includes another state machine, the state machine set division unit 101 re-assigns the included other state machine to the new state machine group, too.

In the case where the state machine to be processed is not included in the stack (step S121: No), the state machine set division unit 101 assigns the state machine to be processed to a new state machine group that includes only the state machine to be processed (step S123).

The state machine set division unit 101 then acquires, one by one, other state machines designated by all transition conditions according to which the state in the state machine to be processed transitions. The acquired other state machine is a state machine on which a transition is dependent.

The state machine set division unit 101 assigns the acquired other state machine to the new state machine group to which the state machine to be processed is assigned in step S123. The state machine set division unit 101 repeatedly performs the assignment process on all state machines on which all transitions in the state machine to be processed are dependent.

The state machine set division unit 101 determines whether or not the assignment process has been performed on all state machines on which all transitions in the state machine to be processed are dependent (step S124). In the case where the assignment process has been performed on all state machines on which all transitions are dependent (step S124: Yes), the state machine set division unit 101 ends the process.

In the case where the assignment process has not been performed on all state machines on which all transitions are dependent (step S124: No), the state machine set division unit 101 performs the assignment process on a state machine on which a transition is dependent and on which the assignment process has not been performed (step S125). After performing the assignment process, the state machine set division unit 101 performs the process in step S124 again.

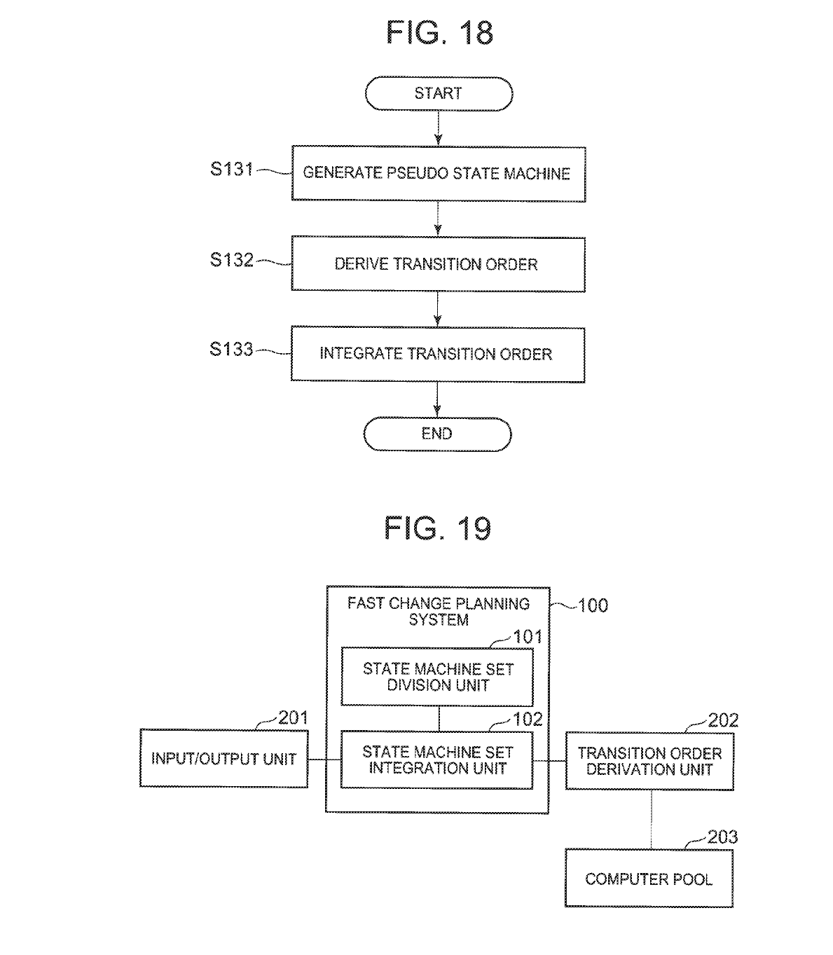

The following describes the process in step S103 in detail, with reference to FIG. 18. FIG. 18 is a flowchart depicting operation of a transition order derivation process and a transition order integration process by the fast change planning system 100.

The state machine set integration unit 102 acquires all transitions in the transition order as the provisional result that designate transition conditions to any state machine in the state machine group to be processed, according to the transition order. The state machine set integration unit 102 generates pseudo states so that the acquired transition is sandwiched between given states, and associates the transition with the pseudo states to generate a pseudo state machine (step S131).

The state machine set integration unit 102 transmits the state machine group to be processed including the pseudo state machine, to the transition order derivation unit 202. The state machine set integration unit 102 acquires the transition order in the transmitted state machine group, from the transition order derivation unit 202 (step S132).

The state machine set integration unit 102 then integrates the acquired transition order with the provisional result, by transferring dependence relationships related to all transitions derived from the pseudo state machine in the acquired transition order to the original transitions (step S133). After integrating the transition order with the provisional result, the state machine set integration unit 102 ends the process.

[Advantageous Effects]

The fast change planning system in this exemplary embodiment can reduce the number of state machines required to be computed together, when computing transition order of a state machine set. The reduction of the number of state machines required to be computed together leads to a reduction in computational effort in generating a change plan for all state machines, so that the change plan is generated more efficiently.

### Exemplary Embodiment 2

### Structure

The following describes Exemplary Embodiment 2 of the present invention, with reference to drawings. FIG. 19 is a block diagram depicting a structural example of Exemplary Embodiment 2 of a fast change planning system according to the present invention. In FIG. 19, the same structural elements as those in Exemplary Embodiment 1 are given the same reference signs, and their description is omitted.

As depicted in FIG. 19, the fast change planning system 100 in this exemplary embodiment has the same structure as the fast change planning system 100 in Exemplary Embodiment 1. This exemplary embodiment, however, differs from Exemplary Embodiment 1 in that the transition order derivation unit 202 is connected to a computer pool 203 outside the fast change planning system 100.

The transition order derivation unit 202 is connected with the computer pool 203 via a communication network or the like, so as to communicate with the computer pool 203. In the case where the transition order derivation unit 202 is connected with the computer pool 203, the transition order derivation unit 202 computes transition order using the computer pool 203. When the computer pool 203 has a high throughput, for example, the transition order derivation unit 202 can compute transition orders in a plurality of state machine groups in parallel.

The state machine set integration unit 102 in this exemplary embodiment requests the transition order derivation unit 202 to simultaneously perform transition order computation processes on a plurality of state machine groups for which transition orders are simultaneously computable.

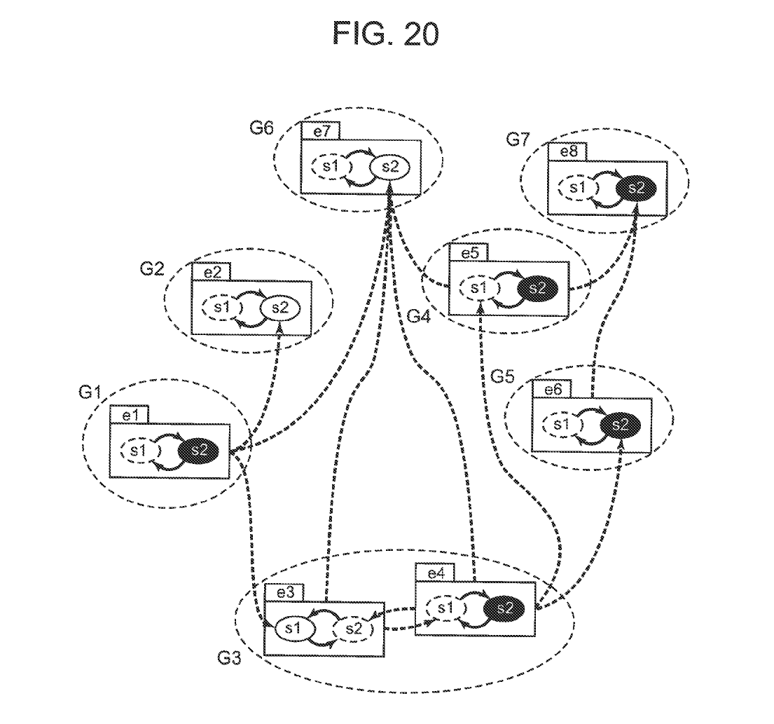

FIG. 20 is an explanatory diagram depicting an example of a state machine group set for which transition order is computable in parallel. As mentioned in Exemplary Embodiment 1, transition order in a state machine group is computed in the case where the state machine group has a transition condition to a state machine in the state machine group itself, and has no dependence relationship with a state machine group of which transition order has not been computed.

In the example depicted in FIG. 20, only a state machine group “G1” is a state machine group that has no dependence relationship with another state machine group. Accordingly, the transition order derivation unit 202 can compute the transition order only for the state machine group “G1”, immediately after the division.

After computing the transition order in the state machine group “G1”, the transition order derivation unit 202 can compute the transition order in state machine groups “G2” and “G3” that have dependence relationships only with the state machine group “G1”.

Since there is no dependence relationship between the state machine groups “G2” and “G3” depicted in FIG. 20, the transition order derivation unit 202 can simultaneously compute the transition order in the state machine groups “G2” and “G3”.

After computing the transition order in the state machine groups “G2” and “G3”, the transition order derivation unit 202 can simultaneously compute the transition order in state machine groups “G4” and “G5”.

After computing the transition order in the state machine groups “G4” and “G5”, the transition order derivation unit 202 can simultaneously compute the transition order in state machine groups “G6” and “G7”.

In the case where there is a plurality of state machine groups for which transition order is computable, the state machine set integration unit 102 successively transmits the state machine groups to the transition order derivation unit 202. The state machine set integration unit 102 successively integrates the transition order computation results received from the transition order derivation unit 202, with the transition order as the provisional result.

[Operation]

The following describes the operation of the fast change planning system 100 in this exemplary embodiment, with reference to FIGS. 14 and 18. The change planning process by the fast change planning system 100 in this exemplary embodiment is basically the same as the change planning process in Exemplary Embodiment 1.

The process in step S103 for transition order derivation and transition order integration is, however, different from the process in step S103 in Exemplary Embodiment 1. The following describes the process in step S103 in this exemplary embodiment. The steps having the same processes as those in Exemplary Embodiment 1 are given the same reference signs, and their description is omitted.

The state machine set integration unit 102 in this exemplary embodiment acquires up to a predetermined limit number of state machine groups for which transition order is computable, from the received a state machine group set. The predetermined limit number is the maximum number of state machine groups that can be computed in parallel by the transition order derivation unit 202 using the computer pool 203. The state machine set integration unit 102 repeatedly performs the process of computing transition orders in a plurality of state machine groups using the transition order derivation unit 202 and the process of integrating the computed transition orders, until the computation is completed for all state machine groups.

In the case where the transition orders in all state machine groups have not been integrated (step S102: No), the state machine set integration unit 102 acquires up to a predetermined limit number of uncomputed state machine groups for which transition order is computable.

The state machine set integration unit 102 sequentially performs the pseudo state machine generation (step S131) and the transition order computation (step S132) for the acquired plurality of state machine groups. Upon receiving transition order relating to a specific state machine group from the transition order derivation unit 202, the state machine set integration unit 102 immediately integrates the received transition order with the transition order as the provisional result (step S133). After the integration, the state machine set integration unit 102 performs the process in step S102 again.

[Advantageous Effects]

The fast change planning system in this exemplary embodiment can speed up all computation for deriving a result, in the case where there is a plurality of state machine groups for which transition orders are simultaneously computable and also a computer pool capable of computing transition orders in a plurality of state machine groups in parallel is available.

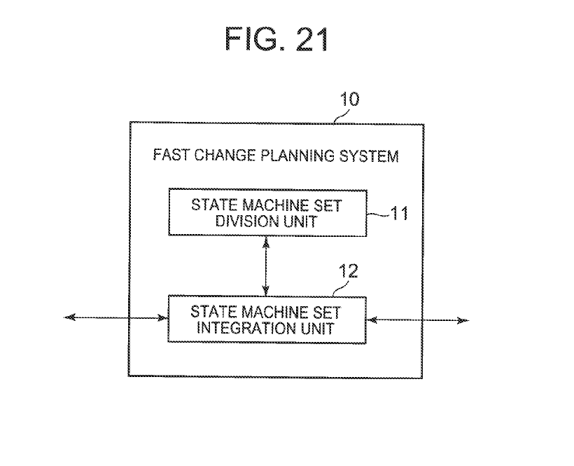

The following describes the overview of the present invention. FIG. 21 is a block diagram schematically depicting a fast change planning system according to the present invention. A fast change planning system 10 according to the present invention includes: a state machine set division unit 11 (e.g. the state machine set division unit 101) which divides a state machine set made up of one or more state machines, into a state machine group set; and a state machine set integration unit 12 (e.g. the state machine set integration unit 102) which integrates transition orders derived from each of the state machine groups obtained by dividing the state machine group set.

With such a structure, the fast change planning system can reduce computational effort in generation of a change plan for a large-scale system.

Moreover, a transition condition according to which a state in a state machine included in the state machine set transitions to another state may relate to a state machine other than the state machine, and the state machine set division unit 11 may divide the state machine set into the state machine group set so that, in the case where sequentially tracing, from one state machine of a plurality of state machines, as many state machines to which one or more transition conditions between the plurality of state machines relate as the transition conditions returns to the one state machine, only the plurality of state machines are included in the same state machine group.

With such a structure, the fast change planning system can divide the state machine set into subgroups each of which is made up of only state machines required to be computed together, on the basis of a circle of a plurality of transition conditions between state machines included in the state machine set.

Moreover, the state machine set division unit 11 may add a pseudo state machine including a state that transitions according to a transition condition relating to a state machine in a state machine group, to the state machine group, and the state machine set integration unit 12 may integrate transition order derived from an original state machine group of the pseudo state machine and transition order derived from the state machine group to which the pseudo state machine is added.

With such a structure, the fast change planning system can integrate the transition orders while taking transition conditions between state machine groups into consideration.

Moreover, in the case where a plurality of state machine groups meet a predetermined condition, the state machine set integration unit 12 may output, to an external device, an instruction to perform processes of deriving transition order from each of the plurality of state machine groups in parallel.

With such a structure, the fast change planning system can process the plurality of state machine groups that meet the predetermined condition, in parallel.

Moreover, the predetermined condition may be that a transition condition is designated to a state machine group from another state machine group and transition order is already derived from the other state machine group.

Moreover, the predetermined condition may be that no transition condition is designated to a state machine group from another state machine group.

With such a structure, the fast change planning system can perform parallel processing while taking dependence relationships between state machine groups into consideration.

The change planning system described in NPL 1 has a problem in that the computational effort necessary to generate a change plan increases exponentially as the number of state machines increases. A computer generating a change plan for a large-scale system fails computation due to extremely high computational effort. Thus, generating a change plan for a large-scale system is difficult when simply using the method described in NPL 1.

There is particularly a need to establish a general-purpose computational efficiency enhancement technique that reduces computational effort in generation of a change plan by reducing the number of state machines required to be computed together and that is not limited to application to specific planning means.

According to the present invention, computational effort in generation of a change plan for a large-scale system can be reduced.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A fast change planning system comprising:
a state machine set division unit which divides a state machine set made up of one or more state machines, into a state machine group set; and
a state machine set integration unit which integrates transition orders derived from each of the state machine groups obtained by dividing the state machine group set.

2. The fast change planning system according to claim 1, wherein a transition condition according to which a state in a state machine included in the state machine set transitions to another state relates to a state machine other than the state machine, and
wherein the state machine set division unit divides the state machine set into the state machine group set so that, in the case where sequentially tracing, from one state machine of a plurality of state machines, as many state machines to which one or more transition conditions between the plurality of state machines relate as the transition conditions returns to the one state machine, only the plurality of state machines are included in the same state machine group.

3. The fast change planning system according to claim 1, wherein the state machine set division unit adds a pseudo state machine including a state that transitions according to a transition condition relating to a state machine in a state machine group, to the state machine group, and
wherein the state machine set integration unit integrates transition order derived from an original state machine group of the pseudo state machine and transition order derived from the state machine group to which the pseudo state machine is added.

4. The fast change planning system according to claim 1, wherein in the case where a plurality of state machine groups meet a predetermined condition, the state machine set integration unit outputs, to an external device, an instruction to perform processes of deriving transition order from each of the plurality of state machine groups in parallel.

5. The fast change planning system according to claim 4, wherein the predetermined condition is that a transition condition is designated to a state machine group from another state machine group and transition order is already derived from the other state machine group.

6. The fast change planning system according to claim 4, wherein the predetermined condition is that no transition condition is designated to a state machine group from another state machine group.

7. A fast change planning method comprising:
dividing a state machine set made up of one or more state machines, into a state machine group set; and
integrating transition orders derived from each of the state machine groups obtained by dividing the state machine group set.

8. The fast change planning method according to claim 7, wherein a transition condition according to which a state in a state machine included in the state machine set transitions to another state relates to a state machine other than the state machine, and
wherein the state machine set is divided into the state machine group set so that, in the case where sequentially tracing, from one state machine of a plurality of state machines, as many state machines to which one or more transition conditions between the plurality of state machines relate as the transition conditions returns to the one state machine, only the plurality of state machines are included in the same state machine group.

9. A non-transitory computer-readable recording medium having recorded therein a fast change planning program that, when executed by a computer:
divides a state machine set made up of one or more state machines, into a state machine group set; and
integrates transition orders derived from each of the state machine groups obtained by dividing the state machine group set.

10. The recording medium according to claim 9, when executed by a computer, wherein a transition condition according to which a state in a state machine included in the state machine set transitions to another state relates to a state machine other than the state machine, and
wherein the state machine set is divided into the state machine group set so that, in the case where sequentially tracing, from one state machine of a plurality of state machines, as many state machines to which one or more transition conditions between the plurality of state machines relate as the transition conditions returns to the one state machine, only the plurality of state machines are included in the same state machine group.
